(19) United States
(12) Patent Application Publication
(10) Pub. No.: US 2007/0277688 A1
(43) Pub. Date: Dec. 6, 2007

(54) Printing couple of a printing unit of a printing press

(75) Inventors: Alfons Baintner, Aystetten (DE); Max Eder, Mering (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/789,547

(22) Filed: Apr. 25, 2007

(30) Foreign Application Priority Data
Apr. 26, 2006 (DE) 10 2006 020 048.9

(51) Int. Cl. B41F 7/04

(52) U.S. Cl. 101/217

(57) ABSTRACT

A printing couple of a printing unit for a web-fed rotary press includes a transfer cylinder, a form cylinder, and an inking couple having at least one roller. The transfer cylinder is coupled to the form cylinder, and the form cylinder is coupled to at least one roller of the inking couple, by side-by-side straight gears arranged in a first gear plane. The drive motor is coupled to the transfer cylinder by side-by-side helical gears arranged in a second gear plane.

### BACKGROUND OF THE INVENTION

1. Field of the Invention

The invention concerns a printing couple of a printing unit of a printing press having a transfer cylinder, a form cylinder, an inking couple with at least one roller, and preferably a damping unit with at least one roller, wherein the cylinders and rollers are coupled to a drive motor by gears.

2. Description of the Related Art

Printing units of web-fed rotary presses, especially newspaper printing presses or commercial web presses, usually have several printing couples, with each printing couple comprising at least a transfer cylinder, a form cylinder, an inking couple, and preferably a dampening unit. Printing couples without a dampening unit are also known. In addition, printing units of this type can also contain impression cylinders, which are also known as satellite cylinders. An impression cylinder can interact with one or more transfer cylinders of different printing couples. Besides printing units that contain these impression cylinders, printing units are also known that do not have impression cylinders, and in printing units of this type without impression cylinders, the transfer cylinders of two printing couples roll on each other. The transfer cylinders are also known as blanket cylinders, and the form cylinders are also known as plate cylinders. The form cylinders or plate cylinders carry printing forms.

The transfer cylinder, the form cylinder, rolls of the inking couple, and possibly dampening units of a printing couple are coupled on the drive side by gears and are thus in a mechanical drive connection with one another via the gears. WO 02/083420 discloses the gears by which the transfer cylinder and the form cylinder of a printing couple are connected with each other. In a printing couple of this type, if the form cylinder and/or the helical gear assigned to the form cylinder is shifted in the axial direction for lateral register adjustment, the helical gears that are coupled with each other are also forced to rotate, and this rotation of the gears must be compensated, according to WO 02/083420, by a circumferential correction with the drive motor. This is complicated and thus a disadvantage.

### SUMMARY OF THE INVENTION

In accordance with the invention, the gears are arranged in several gear planes in such a way that exclusively straight gears are arranged in a first gear plane, such that the gears of the first gear plane couple the transfer cylinder to the form cylinder and the form cylinder to at least one roller of the inking couple that is to be driven and preferably to at least one roller of the dampening unit that is to be driven, and that exclusively helical gears are arranged in a second gear plane, such that the gears of the second gear plane couple a drive motor to the transfer cylinder.

In the printing couple of the invention, no circumferential correction at the drive motor or at other additional, separate adjusting units is necessary during a lateral register adjustment on the form cylinder by axial movement of the form cylinder together with the straight gear of the form cylinder. The first gear plane with the straight gears extends all the way through from the transfer cylinder to the inking couple and possibly the dampening unit. In the printing couple of the invention, the number of gears required and the number of gear planes in which the gears are arranged are minimized, so that, on the one hand, the space requirement can be minimized and, on the other hand, costs can be reduced.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic view of a printing couple of the invention, which is part of a printing unit of a printing press;

FIG. 2 is a highly schematic end view of a printing couple having an inking unit and a dampening unit;

FIG. 3 is a schematic view similar to FIG. 1, with a compensating coupling between the motor and the helical gear;

FIG. 4 is a highly schematic end view of an eight cylinder printing unit having four printing couples;

FIG. 5 is a highly schematic end view of a nine cylinder printing unit having four printing couples and an impression cylinder; and

FIG. 6 is a highly schematic end view of a ten cylinder printing unit having four printing couples and two impression cylinders.

### DETAILED DESCRIPTION OF THE PRESENTLY PREFERRED EMBODIMENTS

FIG. 1 shows a schematic cross section through a printing couple 10 of the invention, which is part of a printing unit of a printing press, namely, a web-fed rotary press. The cross section of FIG. 1 thus shows a transfer cylinder 11, a form cylinder 12 rolling on the transfer cylinder 11, an ink form roller 13 of an inking couple 3 rolling on the form cylinder 12, and another roller 14 of the inking couple rolling on the ink form roller 13. The roller 14 is preferably a vibrator roller of the inking couple. As shown in FIG. 2, at least one additional ink form roller 13′, 14′ of the inking couple and at least one dampening form roller 34 of a dampening unit 4 can roll on the form cylinder 12.

The cylinders 11 and 12 shown in FIG. 1 and the roller 14 of the printing couple 10 are coupled on the drive side by gears, which are arranged in two gear planes 15 and 16. The ink form roller 13 is driven by friction with the form cylinder 12 and the roller 14. Accordingly, the ink form roller 13 is not coupled with the form cylinder 12 and the roller 14 on the drive side by a gear.

Exclusively straight gears are mounted in a first gear plane 15, namely, a straight gear 18 mounted on a shaft 17 of the transfer cylinder 11, a straight gear 20 mounted on a shaft 19 of the form cylinder 12, a straight gear 22 mounted on a shaft 21, a straight gear 24 mounted on a shaft 23 of the roller 14, and possibly other gears 25 mounted on other rollers of the inking couple or of a dampening unit.

The straight gear 18, which is positioned on the shaft 17 of the transfer cylinder 11 and is located in the first gear plane 15, couples the transfer cylinder 11 with the gear 20, which is likewise positioned in the first gear plane 15 and is mounted on the shaft 19 of the form cylinder 12. This straight gear 20 of the form cylinder 12 is coupled with the straight gear 22, which is supported on the shaft 21. The shaft 21 is not the shaft of the ink form roller 13. Accordingly, all gears of the first gear plane 15 that are positioned directly next to each other are coupled on the drive side.

Exclusively helical gears are arranged in the second gear plane 16, namely, a helical gear 26, which is mounted on the shaft 17 of the transfer cylinder 11, and a helical gear 27, which is positioned on a shaft 28 of a drive motor 29, as shown in FIG. 1. The two helical gears 26 and 27 of the second gear plane 16 are coupled on the drive side and engage each other.

As shown in FIG. 3, it is also possible for the helical gear 27 to be mounted on a separate shaft 31 supported in a bearing 32 and coupled with the shaft 28 of the drive motor 29 by a compensating coupling 33.

Accordingly, in the printing couple 10 illustrated in FIG. 1, two gears 18, 26 are positioned exclusively on the shaft 17 of the transfer cylinder 11, namely, on the one hand, the straight gear 18 positioned in the first gear plane 15 and, on the other hand, the helical gear 26 positioned in the second gear plane 16. Only one gear is positioned on each of the other shafts of the cylinders or rollers of the printing couple and on the shaft of the drive motor. The complete mechanical coupling of all of the cylinders and rollers of the printing couple that are to be driven is accomplished via the two gear planes 15 and 16. This minimizes the space requirement and the required number of gears.

If the form cylinder 12 is to be shifted in the axial direction, together with the straight gear 20, as indicated by the double arrow 30, for the purpose of lateral register adjustment, this will not cause any rotational motion of the gears due to the straight gearing within the first gear plane 15, and it is also unnecessary to carry out a circumferential correction at the drive motor 29 or some other circumferential register adjustment unit.

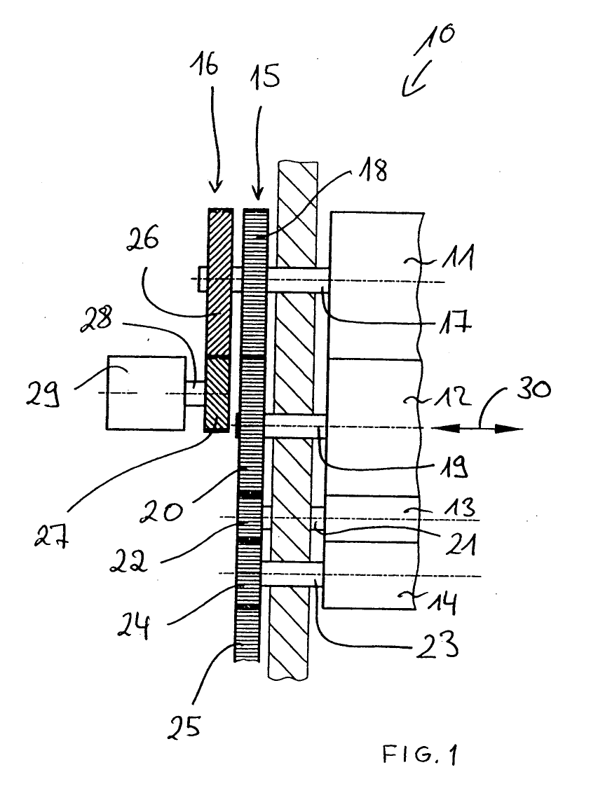

The printing couple 10 illustrated in FIG. 1 can be used in all known types of printing units of a web-fed rotary press. As shown in FIG. 4, for example, it is possible to use four of the printing couples 10 illustrated in FIG. 1 in an 8-cylinder printing unit, and in this case a separate drive is assigned to each printing couple of the 8-cylinder printing unit. Inking and damping units, while present, have been omitted for simplicity.

It is also possible to provide only a single common drive motor for each two printing couples of an 8-cylinder printing unit, and in this case the helical gears 26 of the transfer cylinders 11 of two printing couples engage each other, so that the transfer cylinders 11 of two printing couples 10 are driven by one drive 29.

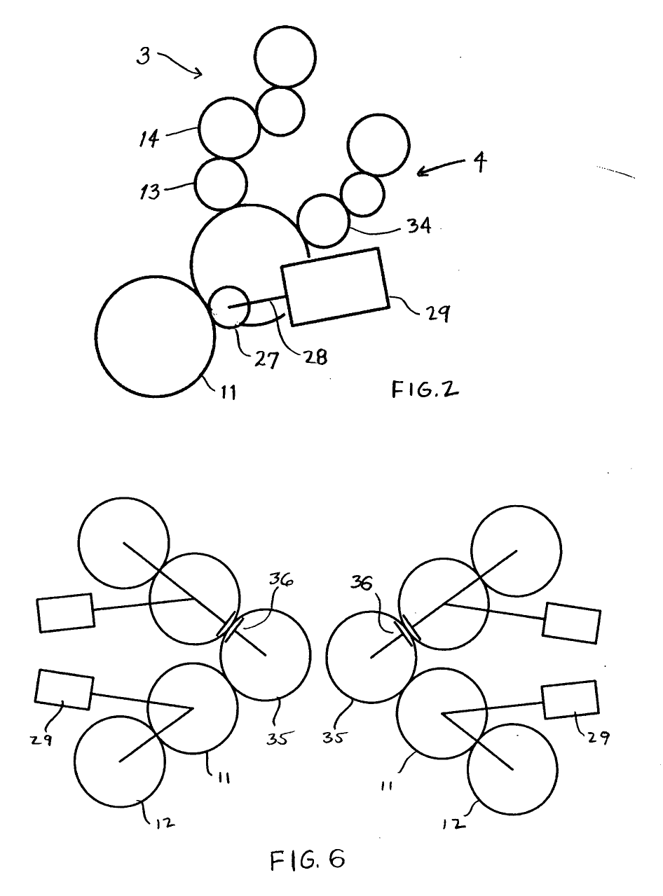

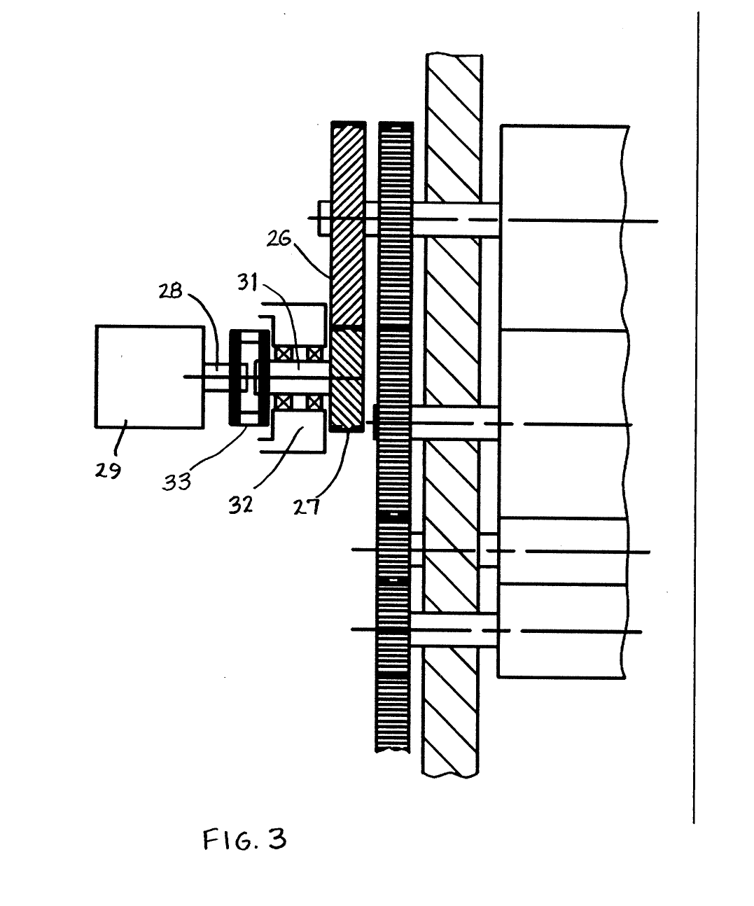

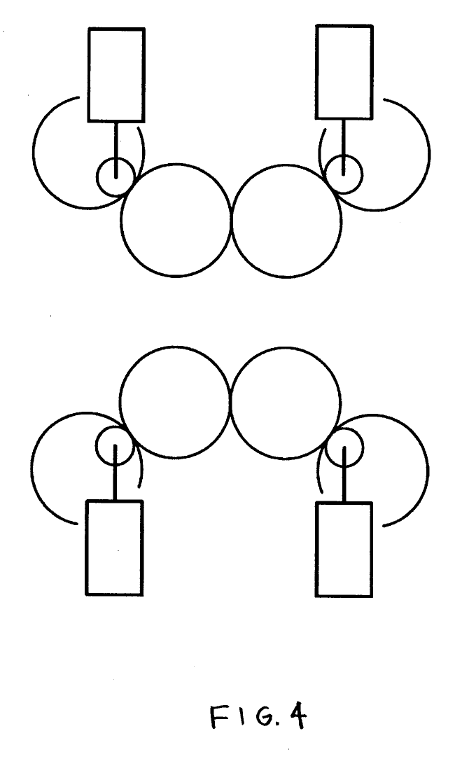

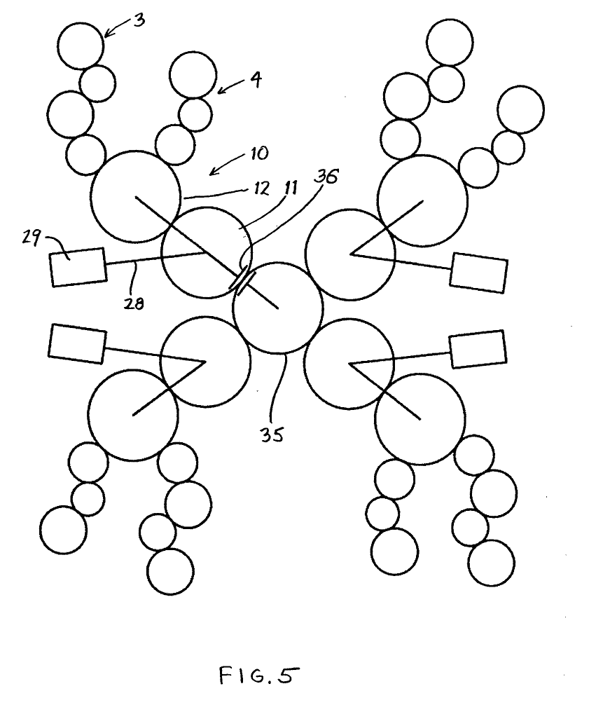

It is also possible to use the printing couple 10 of the invention in so-called satellite printing units. As shown in FIG. 5, these satellite printing units can be designed as a 9-cylinder satellite printing unit with four printing couples 10 and a single impression cylinder 35 or (as shown in FIG. 6) as a 10-cylinder printing unit with four printing couples and two impression cylinders. In this regard, each of the printing couples of a satellite printing unit of this type can then be designed according to FIG. 1, and the impression cylinder or each impression cylinder 35 of the satellite printing units can be driven either by its own drive motor or by a drive motor of one of the printing couples. In the latter case, a coupling 36 is used to couple a motor 29 to impression cylinder 35.

In a satellite printing unit of this type, it is also possible to drive two of the printing couples and one impression cylinder by a common drive, and in this case the helical gears 26 of the transfer cylinders 11 of two printing couples 10 engage each other via an interposed helical gear of the impression cylinder, which is also in the second gear plane, so that the transfer cylinders of two printing couples and the impression cylinder are driven by a common drive.

The use of the printing couple 10 of the invention is not limited to printing units with four printing couples, but rather the printing couple 10 of the invention can also be used in printing units that have three, two, or even only one printing couple. When a printing unit has only a single printing couple 10, an impression cylinder rolls on the transfer cylinder 11 of the printing couple, and this impression cylinder is driven by a gear assigned to it, which can be engaged with the straight gear 18 or even with the helical gear 26 of the transfer cylinder 11.

The printing couple of the invention can be designed for the printing of two or three or four or five or six printed pages arranged side by side in the axial direction of the form cylinder 12 with one or two printed pages arranged in the circumferential direction of the form cylinder 12.

The printing couple of the invention is preferably realized as a 2/2 printing couple or as a 4/2 printing couple or as a 6/2 printing couple or as a 4/1 printing couple, where the first number indicates the number of printed pages arranged side by side in the axial direction, and the second number indicates the number of printed pages arranged one after the other in the circumferential direction.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A printing couple of a printing unit for a web-fed rotary press, the couple comprising:
a transfer cylinder;
a form cylinder;
an inking couple comprising at least one roller;
side-by-side straight gears arranged in a first gear plane to couple the transfer cylinder to the form cylinder, and the form cylinder to the at least one roller of the inking couple; and
side-by-side helical gears arranged in a second gear plane to couple a drive motor to the transfer cylinder.

2. The printing couple of claim 1 wherein one of the straight gears and one of the helical gears are arranged on a shaft of the transfer cylinder.

3. The printing couple of claim 2 wherein another one of the helical gears is arranged on a shaft of the drive motor and is coupled to the helical gear on the shaft of the transfer cylinder.

4. The printing couple of claim 2 wherein another one of the helical gears is mounted on a separate shaft, the couple further comprising a compensating coupling which couples the separate shaft to a shaft of the drive motor.

5. The printing couple of claim 2 wherein another one of the straight gears is arranged on a shaft of the form cylinder and is coupled to the one of the straight gears on the shaft of the transfer cylinder.

6. The printing couple of claim 5 wherein another one of the straight gears is arranged on a shaft of the roller of the inking couple and is coupled to another one of the straight gears which in turn is coupled to the straight gear on the shaft of the form cylinder.

7. The printing couple of claim 5 further comprising a dampening unit having a roller on a shaft, wherein one of the side-by-side straight gears is mounted on the shaft of the roller of the dampening unit and is coupled to the straight gear on the shaft of the form roller.

8. The printing couple of claim 1 further comprising a dampening unit having a roller, wherein the side-by-side straight gears are arranged to couple the transfer cylinder to the roller of the dampening unit.
